(19) United States
(12) Patent Application Publication
(10) Pub. No.: US 2010/0037977 A1
(43) Pub. Date: Feb. 18, 2010

(54) UNIVERSAL PIPE CAP

(76) Inventors: Rick Rahimzadeh, Canoga Park, CA (US); John F. Hanna, Newbury Park, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/540,122

(22) Filed: Aug. 12, 2009

Related U.S. Application Data
(60) Provisional application No. 61/088,284, filed on Aug. 12, 2008.

(51) Int. Cl. F16L 55/115

(52) U.S. Cl. 138/96 R; 138/90

(57) ABSTRACT

The universal pipe cap includes a fluid impervious base and an adjustable sleeve extending from the base and configured to couple to a plurality of pipe ends that vary in size. A securement mechanism selectively sealingly engages the adjustable sleeve to one of a plurality pipe ends so that the adjustable sleeve and the fluid impervious base are able to cooperate with one another to cap the pipe end. The adjustable sleeve is made from a flexible material and may attach to pipe ends that are either larger in diameter or smaller in diameter than the inside diameter of the adjustable sleeve.

### BACKGROUND OF THE INVENTION

The present invention relates to a universal pipe cap. More particularly, the invention relates to a universal piping filler and drain cap having a threaded central shaft embedded in a rubber housing capable of attaching to an external device.

Pipe end caps are primarily designed for temporarily or permanently closing the ends of all types of piping and plumbing systems such as waste pipes, waste vents, storm drains or water-fluid-gas pipe systems. There are many instances during new construction and during commercial or residential remodeling when industry professionals or homeowners may desire to temporarily or permanently cap a pipe. This is particularly desirable, for example, when testing newly installed piping or making repairs to existing piping systems. In one example, caps are used to pressurize a piping system to test the installation and inspect for material defects. In another example, piping lines dedicated for future use are installed and capped until needed. Alternatively, piping lines being relocated during a remodel are temporarily capped while the new piping is installed. Pipe ends may also be temporarily capped and left accessible to allow for servicing and cleaning of the piping system. Other pipe ends may be permanently capped and abandoned.

A variety of piping systems may be installed when piping residential and commercial structures. Such piping systems may include waste pipe, waste vents, hot and cold potable water piping, natural or liquid gas pipes, landscaping water pipes, roof and storm water drainage pipes, fire sprinkler water pipes, etc. The piping systems may require different pipe sizes depending upon maximum requisite load capacity of each piping system, as calculated by piping engineers. Pipe size may also be regulated by local or federal piping codes. These systems must be tested and approved by local building inspectors after each stage of piping installation. Testing is accomplished by temporarily capping or sealing all the ends of the piping outlets to allow pressure to be applied within the system, generally by the use of air or water, to expose possible installation and material defects. After successfully completing the tests, the piping systems are drained, the end caps are removed and installation is resumed. The testing process is repeated for each piping system until the project is completed.

The preceding examples provide a limited sampling of the abundance of applications for piping caps. Caps necessarily come in an array of sizes and materials to meet the requirements of the plurality of piping systems. For example, a small three bathroom residence may have four common pipe sizes for waste and vent piping systems, including 1.5″, 2″, 3″ and 4″ diameters. Each pipe diameter is used according to the demand of the fixture it serves. For example, a water closet drain is normally serviced by a 3″ or 4″ pipe size. Lavatory and kitchen sink drains are normally serviced by 1.5″ or 2″ pipe sizes. Additionally, building codes may require that each drain be provided with a separate vent pipe to allow the drain to breathe. Each of these pipe ends must be capped and pressurized during the construction or remodeling process. Additionally, each piping system may use a different piping material and installation method. Piping materials usable with such systems include plain and threaded end cast iron pipe, copper tubing, steel pipe and a variety of plastic pipe. The type and size of acceptable piping material may vary by applicable jurisdiction.

The quantity of caps required to test piping systems can vary depending on the size and nature of the project. A small project, such as remodeling a three bathroom residence, probably requires a minimum of approximately twenty caps of four varying pipe sizes to properly test the waste and vent systems. A multi-family residence, apartment building, condominium, hotel, medical facility, high rise structure or other large commercial building would require hundreds, if not thousands, of caps per project to simply perform testing and installation. Of course, pipe sizes in commercial structures tend to be larger due to increased demand of the piping systems. Pipes serving commercial facilities generally range between 1.5″ and 8″ for waste and vent systems, 0.5″ and 6″ for potable water systems, 0.5″ and 3″ for gas systems and between 2″ and 8″ for the storm water system.

Currently, the most popular method of capping piping systems is by way of a single diameter pipe cap. The most common type of pipe cap used for this type of capping is made of an elastomeric material such as rubber, synthetic rubber, silicon, a plastic material or a combination thereof. The cap is manufactured to form to the contour of the pipe end and may be fastened to the pipe end with a stainless steel worm-drive clamp. These caps, once known as “Jim Caps,” are reusable and often used daily by plumbing professionals, builders, service persons and homeowners. Jim Caps are often inventoried at piping wholesalers, home centers and hardware establishments such as Lowe's or Home Depot. But, each of these caps can only accommodate a single size of pipe and do not enable attachment of another threaded valve body, hose-bib, air test gauge or other similar device.

There exists, therefore, a significant need for a universal pipe cap having a threaded central shaft embedded in an outer rubber housing capable of fitting around the outside diameter at the end of any one of a number of variously sized piping fixtures. Such a universal pipe cap should include a generally impermeable rubber wall capable of reducing or stopping liquid flow at the end of a tube, should include an 0-ring or a knurl pattern ridged along the internal surface for hermetically securing the cap to the tube and should provide access to the piping system through the central threaded shaft, which is attachable to a similarly threaded valve body, hose-bib, air test gauge or similar device. The present invention fulfills these needs and provides further related advantages.

### SUMMARY OF THE INVENTION

The universal pipe cap disclosed herein includes a fluid impervious base and an adjustable sleeve extending from the fluid impervious base and configured to couple to one of a plurality of pipe ends that vary in size. The universal pipe cap may also include a securement mechanism that selectively sealingly engages the adjustable sleeve to one of a plurality of pipe ends. In turn, the securement mechanism, the adjustable sleeve and the fluid impervious base cooperate to cap the pipe end. In a particularly preferred embodiment, the universal pipe cap further includes a passageway extending through the fluid impervious base for being in fluid communication with the pipe. Such a coupler is disposed between the passageway and the fluid impervious base. Accordingly, the coupler should form an airtight and watertight seal between the passageway and the fluid impervious base. The coupler may include a valve assembly, a push-pull fitting, a quick-disconnect fitting, a compression fitting, a twist lock fitting, an internally threaded fitting or an externally threaded fitting. A fluid regulator that includes a pipe, a sensor, a faucet, a meter air test gauge, a hose-bib or a valve may selectively removably engage with the coupler. The fluid regulator would then be in fluid communication with the pipe through the passageway when the universal pipe cap is attached to a pipe end.

The universal pipe cap caps the pipe end by fitting the adjustable sleeve over the opening. In one embodiment, the inside diameter of the adjustable sleeve is smaller than an outside diameter of one of the plurality of pipe ends. Alternatively, the inside diameter of the adjustable sleeve may be larger than the outside diameter of one of the plurality of pipe ends. In this embodiment, it is particularly preferred that the securement mechanism be an adjustable clamp that has a band that can encompass the adjustable sleeve. Here, the securement mechanism includes a lock to selectively tension the band around the exterior of the adjustable sleeve to engage the sleeve with the outer diameter of the pipe end. The adjustable sleeve may further include a rib that facilitates an airtight and watertight seal to the pipe end. Preferably, the adjustable sleeve is manufactured from a flexible material that enables the flexible sleeve to fit to pipe ends that are both smaller in diameter and larger in diameter than the inside diameter of the adjustable sleeve.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view a universal pipe cap attached to an end of a tube and having a faucet engaged thereto;

FIG. 2 is a perspective view of the universal pipe cap in accordance with the present invention;

FIG. 3 is an internal perspective view of the universal pipe cap;

FIG. 4 is a side view of the universal pipe cap;

FIG. 5 is a top down view of the universal pipe cap;

FIG. 6 is a bottom up view of the universal pipe cap; and

FIG. 7 is a partial cross-sectional view of the universal pipe cap of FIG. 3, taken about the line 7-7.

### DETAILED DESCRIPTION OF THE PREFERRED EMBODIMENTS

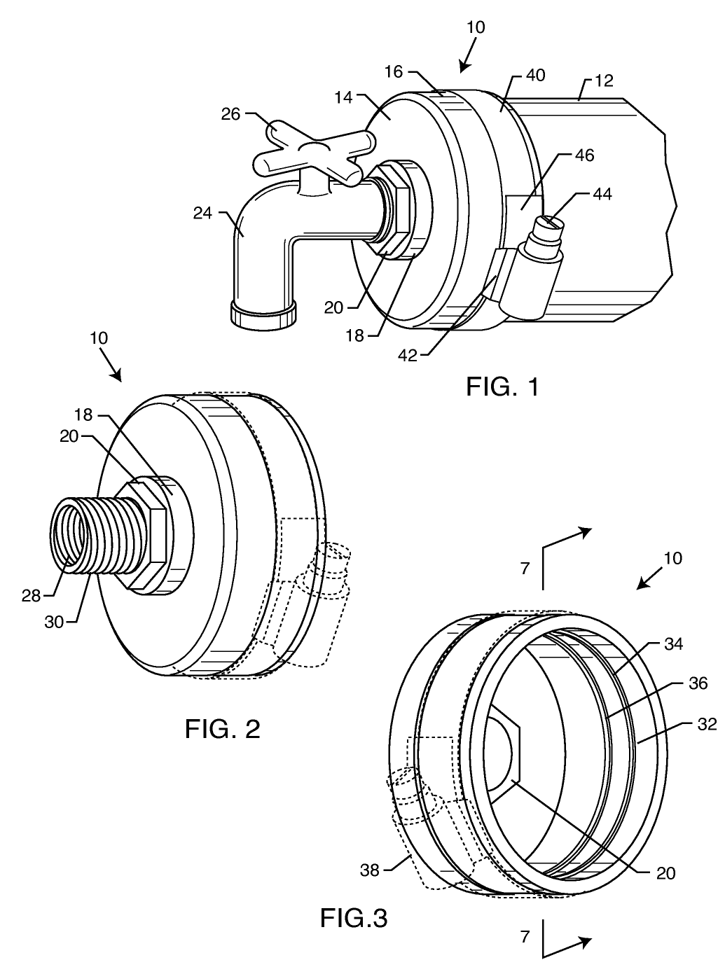

As shown in the drawings for purposes of illustration, the present invention for a universal pipe cap is referred to generally by the reference number 10. In FIG. 1, the cap 10 is shown fit over a pipe 12. The inside diameter of the cap 10 may be slightly smaller than, approximately the same size as or, less preferably, slightly larger in diameter than the outside diameter of the pipe 12. The preferred method of securing the cap 10 to the pipe 12 will be further described herein. Accordingly, the cap 10 is capable of completely sealing the pipe 12 thereby restricting liquid flow at the end of the pipe 12. In one embodiment, a separate liquid regulation device may be attached to the cap 10. In a preferred embodiment, the cap 10 includes a fluid impervious base 14 for at least partially blocking the open end (not shown) of the pipe 12. The fluid impervious base 14 restricts the flow of water or other liquid through the pipe 12, as described below. The cap 10 has a wide variety of applications applicable to residential and commercial piping systems. The cap 10 can be used as a temporary or permanent solution to substantially restrict, completely block or regulate liquid exiting the tube 12. In this regard, the cap 10 is often useful for testing and installing piping systems in new constructions or in conjunction with remodeling. The cap 10 may also include features such as being a reversible and/or dual size end cap as disclosed in U.S. Pat. No. 6,408,887 to Rahimzadeh et al. and U.S. Pat. No. 6,935,380 to Rahimzadeh et al., of which the contents of each patent are herein incorporated by reference. Incorporating the reversible and/or dual size end cap features of the '887 and '380 patents enables the cap 10 to have a wider functionality and application for use with the aforementioned piping systems.

The cap 10 is preferably manufactured from a resilient flexible material able to withstand pressures commonly associated with piping systems. Accordingly, the cap 10 should meet or exceed the piping specifications and government regulations governing the requisite safety factor of domestic and commercial piping systems. The resilient flexible material may include elastomeric material (e.g. rubber or synthetic rubber), plastic, vinyl or silicon. The cap 10 may also be made from a variety of other materials assuming, of course, that those materials can restrict, regulate or prevent liquid from exiting the open end of the pipe 12. The flexibility of the sleeve 16 enables the cap 10 to fit over the external diameter of the pipe 12 as shown in FIG. 1. Of course, the flexibility of the sleeve 16 may vary from that of the fluid impervious base 14. Although, in a preferred embodiment the fluid impervious base 14 and the sleeve 16 are manufactured out of the same material having the same material properties and flexibilities. Accordingly, the fluid impervious base 14 and the sleeve 16 should be of unitary construction.

The fluid impervious base 14 includes a rubber reinforcement 18 integral to a coupler 20 that has a central passageway 22 (FIG. 7) through the base 14. The reinforcement 18 is preferably the same material as the fluid impervious base 14 and the sleeve 16. The coupler 20 should include a mechanism capable of engaging or attaching to any one of a plurality of flow regulators, sensors or meters. The coupler 20 may also be configured to attach to additional piping. Here, the coupler 20 allows liquid within the pipe 12 to exit through the central passageway 22 of the cap 10 and into another pipe or piping system. Accordingly, the coupler 20 enables a user to fill or drain a particular piping system for the purpose of testing installation or locating material defects in an existing piping system. For example, FIG. 1 illustrates a faucet 24 screwingly engaged to the coupler 20. In this embodiment, water flow within the pipe 12 is regulated with a handle 26. A user rotates the handle 26 counterclockwise to open the faucet 24 thereby allowing liquid within the pipe 12 to exit the piping system. Alternatively, a user may rotate the handle 26 clockwise to close off the faucet 24 thereby preventing liquid from exiting the pipe 12. Threaded attachment of the faucet 24 to the coupler 20 is simply an exemplary example of a device that may attach to the coupler 20. In alternative embodiments, the coupler 20 may attach to, in addition to the faucet 24, an air test filler gauge, a hose-bib, a valve, another pipe, or other similar device. These devices may threadingly engage the coupler 20 or may engage the coupler 20 by any other attachment mechanism known in the art. A threaded end stop or other push-on type stop (not shown) are attachable to the coupler 20 by any method known in the art capable of plugging the central passageway 22 to prevent liquid from exiting the pipe 12. In this embodiment, the stop is meant to be a more permanent solution for preventing liquid from exiting the pipe 12 relative to, for example, the faucet 24. The stop is particularly useful when the end of the pipe 12 is not going to be accessed or is rarely accessed.

The coupler 20 extends through the fluid impervious base 14 as shown in FIGS. 2 and 3, and more specifically in FIG. 7. The coupler 20 may have a hex shape to provide additional strength during valve attachment. The coupler 20 enables a user to fill or drain the pipe 12 when the universal piping filler and drain cap 10 is secured to the pipe 12. The coupler 20 may securely receive a test gauge, air source or water source. The coupler 20 is permanently integrated into the base 14 via the rubber reinforcement 18 and forms an airtight and a watertight seal therebetween. The seal between the coupler 20 and the reinforcement 18 must be able to withstand pressures normally associated with residential or commercial piping systems. The coupler 20 may attach to the reinforcement 18 by lock nuts, washers and grommets, or by bonding the rubber reinforcement 18 to the metallic materials of the coupler 20. As best shown in FIGS. 2 and 7, the coupler 20 includes a set of internal threads 28 and a set of external threads 30. The threads 28, 30 are capable of receiving a threaded valve body, threaded pipe, hose-bib, air test gauge or similar device, commonly used in plumbing systems. The coupler 20 is merely one example of a type of fitting compatible with the cap 10. Other types of fittings compatible with valve assemblies, and specifically the cap 10, include push-pull fittings, quick-disconnect fittings, compression fittings, twist lock fittings, internal and externally threaded fittings, etc.

FIG. 3 illustrates an interior surface 32 of the cap 10 that engages the outside diameter of the pipe 12, shown generally in FIG. 1. In one embodiment, the interior surface 32 alone is used to create a seal with the pipe 12. Alternatively, and more preferably, FIG. 3 illustrates the interior surface 32 having a pair of ridges 34, 36. The ridges 34, 36 are preferably raised O-ring beads or knurls protruding out from the interior surface 32 of the cap 10. The ridges 34, 36 may be formed as part of the material of the interior surface 32. The ridges 34, 36 are preferred because they assist in forming a positive seal of the interior surface 32 of the cap 10 to the pipe 12. A clamp 38 (shown in phantom in FIG. 3) helps form the seal between the sleeve 16 and the pipe 12. As best shown in FIG. 1, a user tightens a band 40 encompassing the outer diameter of the sleeve 16 to force the ridges 34, 36 into contact with the outer diameter of the pipe 12. The band 40 is retained within a harness 42 integral to the clamp 38. Tightening the band 40 about the exterior diameter of the sleeve 16 causes slight deformation of the sleeve 16 inward toward the outer diameter of the pipe 12. A screw 44 is tightened within the harness 42 to secure and substantially retain the band 40 in a tensioned position about the exterior diameter of the sleeve 16. The band 40 is tightened by pulling an end 46 away from the harness 42, as shown in FIG. 1. In turn, the diameter of the band 40 decreases. The band 40 is released from the exterior diameter of the sleeve 16 by unscrewing the screw 44 from within the harness 42 and thereafter pulling the end 46 of the band 40 in the opposite direction, i.e. toward the harness 42 in FIG. 1.

The clamp 38 provides additional pressure along the exterior diameter of the sleeve 16 to ensure proper tightening of the sleeve 16 to the outer diameter of the pipe 12. In turn, the sleeve 16 forms an airtight and watertight seal with the pipe 12 via the ridges 34, 36. The clamp 38 may be made from a variety of materials that include plastic, stainless steel or another flexible, yet resilient material. For example, the clamp 38 may be a worm-drive clamp. The band 40 is preferably a metal band substantially resistant to stretching or deformation. But, a person of ordinary skill in the art will readily recognize that any type of band capable of encompassing the outer diameter of the sleeve 16 and simultaneously providing additional tension thereto to improve the contact between the outer diameter of the pipe 12 and the ridges 34, 36 may be used as well. The band 40 may also be set into a set of loops or recesses (not shown) in the sleeve 16 to prevent the band 40 from subsequently slipping off the sleeve 16 after being tightened thereto.

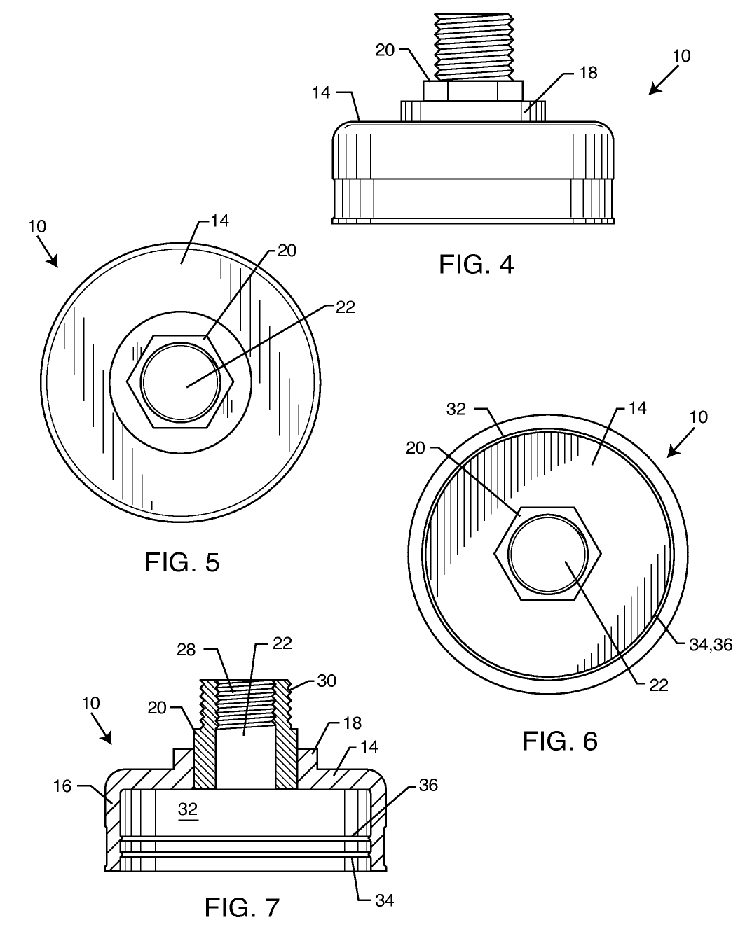

FIGS. 4-6 provide alternative views of the universal plumbing filler cap 10. FIG. 4 illustrates the coupler 20 extending away from the fluid impervious base 14. The raised coupler 20 enables a user to better access and attach a device to the cap 10, as described above. FIGS. 5 and 6 are exemplary views of the central passageway 22 extending through the fluid impervious base 14. The central passageway 22 provides external access to the interior of the pipe 12 when the cap 10 is attached thereto. FIG. 6 also illustrates the ridges 34, 36 protruding out from the interior surface 32 of the sleeve 16.

FIG. 7 illustrates a cross-sectional view of the cap 10 having the central passageway 22 extending through the fluid imperious base 14. FIG. 7 also illustrates the internal threads 28 disposed within the interior of the central passageway 22 and capable of receiving any one of a number of devices having reciprocal threads thereon. The external threads 30 formed along the exterior of the coupler 20 are also capable of receiving similar devices having reciprocal threads. Of course, the central passageway 22 is formed in the coupler 20, which is integrally formed to the base 14 via the reinforcement 18. Moreover, FIG. 7 illustrates the ridges 34, 36 protruding out from the interior surface 32 of the cap 10. The ridges 34, 36 are used to seal the sleeve 16 to the outer diameter of the pipe 12, as described above.

Although several embodiments have been described in some detail for purposes of illustration, various modifications may be made to each without departing from the scope and spirit of the invention. Accordingly, the invention is not to be limited, except as by the appended claims.

What is claimed is:

1. A universal pipe cap, comprising:
a fluid impervious base;
an adjustable sleeve extending from the fluid impervious base and configured to couple to one of a plurality of pipe ends that vary in size; and
a securement mechanism that selectively sealingly engages the adjustable sleeve to one of the plurality of pipe ends, wherein the adjustable sleeve and the fluid impervious base cooperate to cap the pipe end.

2. The pipe cap of claim 1, including a passageway extending through the fluid impervious base for being in fluid communication with the pipe.

3. The pipe cap of claim 2, including a coupler disposed between the passageway and the fluid impervious base.

4. The pipe cap of claim 3, wherein the coupler forms an airtight and watertight seal between the passageway and the fluid impervious base.

5. The pipe cap of claim 3, wherein the coupler includes a valve assembly, a push-pull fitting, a quick-disconnect fitting, a compression fitting, a twist lock fitting, an internally threaded fitting, or an externally threaded fitting.

6. The pipe cap of claim 3, including a fluid regulator selectively removably engageable with the coupler for being in fluid communication with the pipe through the passageway.

7. The pipe cap of claim 6, wherein the fluid regulator comprises a pipe, a sensor, a faucet, a meter, an air test gauge, a hose-bib, or a valve.

8. The pipe cap of claim 1, wherein an inside diameter of the adjustable sleeve is smaller than an outside diameter of one of the plurality of pipe ends.

9. The pipe cap of claim 1, wherein the securement mechanism comprises an adjustable clamp.

10. The pipe cap of claim 9, wherein the clamp includes a band that encompasses the adjustable sleeve.

11. The pipe cap of claim 10, wherein the securement mechanism includes a lock to selectively tension the band to the adjustable sleeve.

12. The pipe cap of claim 1, wherein the adjustable sleeve includes a rib that facilitates an airtight and watertight seal between the adjustable sleeve and the pipe end.

13. The pipe cap of claim 1, wherein the adjustable sleeve comprises a flexible material.

14. A universal pipe cap, comprising:
a fluid impervious base;
an adjustable sleeve extending from the fluid impervious base and configured to couple to one of a plurality of pipe ends that vary in size;
a passageway extending through the fluid impervious base for being in fluid communication with a pipe;
a coupler disposed between the passageway and the fluid impervious base; and
a securement mechanism comprising an adjustable clamp that selectively sealingly engages the adjustable sleeve to one of the plurality of pipe ends, wherein the adjustable sleeve includes a rib that cooperates with the fluid impervious base to provide an airtight and watertight cap to the pipe end.

15. The pipe cap of claim 14, wherein the coupler forms an airtight and watertight seal between the passageway and the fluid impervious base.

16. The pipe cap of claim 14, including a fluid regulator selectively removably engageable with the coupler for being in fluid communication with the pipe through the passageway.

17. The pipe cap of claim 16, wherein the coupler includes a valve assembly, a push-pull fitting, a quick-disconnect fitting, a compression fitting, a twist lock fitting, an internally threaded fitting, or an externally threaded fitting and the fluid regulator comprises a pipe, a sensor, a faucet, a meter, an air test gauge, a hose-bib, or a valve.

18. The pipe cap of claim 14, wherein an inside diameter of the adjustable sleeve is smaller than an outside diameter of one of the plurality of pipe ends.

19. The pipe cap of claim 14, wherein the clamp includes a band that encompasses the adjustable sleeve that comprises a flexible material.

20. The pipe cap of claim 14, wherein the securement mechanism includes a lock to selectively tension the band to the adjustable sleeve.
